(19) United States
(12) Patent Application Publication
(10) Pub. No.: US 2014/0337696 A1
(43) Pub. Date: Nov. 13, 2014

(54) METHOD AND APPARATUS FOR OBTAINING WEB DATA

(71) Applicant: TENENT TECHNOLGOY (SHENZHEN) COMPANY LIMITED, Shenzhen (CN)

(72) Inventor: Gang Liu, Shenzhen (CN)

(21) Appl. No.: 14/126,436

(22) PCT Filed: Jan. 11, 2013
(86) PCT No.: PCT/CN2013/070352

§ 371 Date: Dec. 15, 2013

(30) Foreign Application Priority Data
Feb. 1, 2012 (CN) 201210022277.5

(51) Int. Cl. G06F 17/22

(52) U.S. Cl. CPC G06F 17/2235; G06F 17/2247
USPC 715/205

(57) ABSTRACT

Various embodiments provide methods and apparatus for obtaining web data. An exemplary method includes receiving file information from a terminal and obtaining a web data link corresponding to the file information, and sending the web data link to the terminal for the terminal to obtain web data based on the web data link. The disclosed methods and apparatus can improve efficiency of obtaining web data and reduce waste of web sources.

### CROSS-REFERENCES TO RELATED APPLICATIONS

This application claims priority to Chinese Patent Application No. CN201210022277.5, filed on Feb. 1, 2012, the entire contents of which are incorporated herein by reference.

### FIELD OF THE DISCLOSURE

The present disclosure relates to the field of web technology, and more particularly, relates to methods and apparatus for obtaining web data.

### BACKGROUND

With development of internet technology, data downloading has become an important method for obtaining web data resource. As internet technology is rapidly developed, data downloading technologies are constantly emerging, for example, including P2P (Peer to Peer) technology, P2SP (Peer to Server & Peer) technology, cloud downloading technology (i.e., a downloading technology based on cloud computing, often referred to as offline downloading), etc.

Based on these downloading technologies, current download protocols include HTTP (Hyper Text Transfer Protocol), eMule Protocol, BT (BitTorrent) Protocol, etc. Each protocol provides links with different format for users to access a corresponding web resource and then to download data. For example, HTTP provides a URL (Universal Resource Locator) link, eMule protocol provides an ed2k (eDonkey2000 network) link, and BT protocol provides a Torrent link.

However, current technologies have certain issues. These issues include at least the followings. First, users can only access web resources through certain protocol links. Under some circumstances, users may conveniently obtain information of some web data. Corresponding links of such web data, however, cannot be obtained or cannot be conveniently obtained. For example, users may come across a poster on a forum regarding a latest movie, but there are no downloading links provided directly on the forum for this movie. To obtain a corresponding link for downloading this movie, the users may then have to use various other methods, e.g., searching by web search engines and browsing various major websites, and then conduct the downloading process. The entire process for obtaining web data is not efficient. In addition, considering the large amount of web users, web resources are significantly wasted when each web user conducts operations including multiple browsing, multiple searching, etc. It is therefore desirable to provide methods and apparatus for efficiently obtaining web data with reduced waste of web sources.

### BRIEF SUMMARY OF THE DISCLOSURE

This disclosure proposes methods and apparatus for efficiently obtaining (e.g., downloading) web data with reduced waste of web sources.

According to various embodiments, there is provided a method for obtaining web data by pre-storing a corresponding relationship between file characteristic information and a corresponding web data link. In this method, file information sent from a terminal can be received and the file information can provide the file characteristic information. At least based on the pre-stored corresponding relationship, a web data link corresponding to the file information can be obtained. The web data link can be sent to the terminal for the terminal to obtain web data based on the web data link.

According to various embodiments, there is also provided a server. The server can include a storing module, a receiving module, an obtaining module, and a sending module. The storing module can be configured to store a corresponding relationship between file characteristic information and a corresponding web data link. The receiving module can be configured to receive file information from a terminal. The obtaining module can be configured to obtain a web data link corresponding to the file information at least based on the corresponding relationship. The file information can provide the file characteristic information. The sending module can be configured to send the web data link to the terminal for the terminal to obtain web data corresponding to the web data link.

According to various embodiments, there is further provided a method for obtaining web data by sending file information to a server for the server to obtain a web data link corresponding to the file information. The file information can provide file characteristic information and the web data link can be obtained at least based on a corresponding relationship between the file characteristic information and a corresponding web data link. The web data link can be received from the server. Web data corresponding to the web data link can then be obtained.

According to various embodiments, there is further provided a terminal. The terminal can include a sending module, a receiving module, an obtaining module, and a reporting module. The sending module can be configured to send file information to a server for the server to obtain a web data link corresponding to the file information. The file information can provide file characteristic information and the web data link can be obtained at least based on a corresponding relationship between the file characteristic information and a corresponding web data link. The receiving module can be configured to receive the web data link sent from the server. The obtaining module can be configured to obtain web data based on the web data link. The reporting module can be configured to obtain the file information and the web data link and to send the obtained file information and the web data link to the server.

As disclosed herein, the efficiency for obtaining web data can be improved by, for example, obtaining file information from a terminal; obtaining a web data link corresponding to the file information; and sending the web data link back to the terminal for the terminal to obtain corresponding web data based on the web data link.

Other aspects or embodiments of the present disclosure can be understood by those skilled in the art in light of the description, the claims, and the drawings of the present disclosure.

### BRIEF DESCRIPTION OF THE DRAWINGS

FIG. 1 depicts an exemplary server-side process flow illustrating a method for obtaining web data in accordance with various disclosed embodiments;

FIG. 2 depicts an exemplary network architecture illustrating a method for obtaining web data in accordance with various disclosed embodiments;

FIG. 3 depicts an exemplary terminal-side process flow illustrating a method for obtaining web data in accordance with various disclosed embodiments;

FIG. 4 depicts an exemplary web data downloading process by a terminal when obtaining web data in accordance with various disclosed embodiments;

FIG. 5 depicts an exemplary process flow illustrating a method for obtaining web data in accordance with various disclosed embodiments;

FIG. 6 depicts an exemplary server in accordance with various disclosed embodiments;

FIG. 7 depicts an exemplary terminal in accordance with various disclosed embodiments;

FIG. 8 depicts an exemplary environment incorporating certain disclosed embodiments; and

FIG. 9 depicts a block diagram of an exemplary computer system in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

As disclosed herein, a server can obtain file information sent from a terminal and obtain web data link corresponding to the file information. The server can then send the web data link to the terminal for the terminal to obtain corresponding web data based on the web data link. The efficiency of obtaining web data can then be improved and waste of web sources can be reduced.

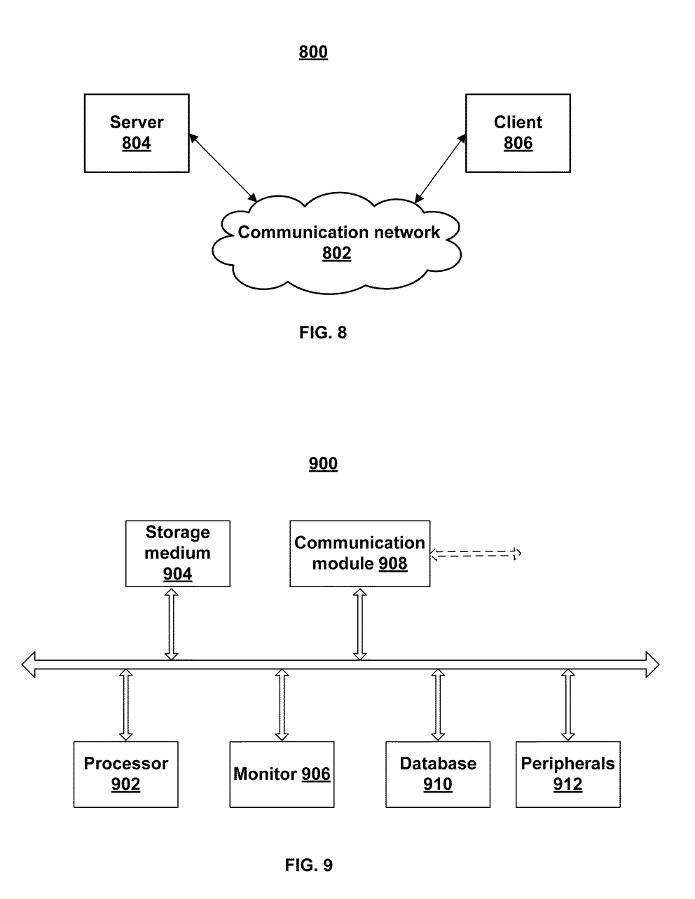

FIG. 8 depicts an exemplary environment 800 incorporating certain disclosed embodiments. As shown in FIG. 8, environment 800 may include a server 804, a terminal or a client 806, and/or a communication network 802. The server 804 and the client 806 may be coupled through the communication network 802 for information exchange, such as obtaining web data. Although only one client 806 and one server 804 are shown in the environment 800, any number of clients 806 or servers 804 may be included, and other devices may also be included.

Communication network 802 may include any appropriate type of communication network for providing network connections to the server 804 and client 806 or among multiple servers 804 or clients 806. For example, communication network 802 may include the Internet or other types of computer networks or telecommunication networks, either wired or wireless.

A client, as used herein, may refer to any appropriate user terminal with certain computing capabilities, such as a personal computer (PC), a work station computer, a server computer, a hand-held computing device (tablet), a smart phone or mobile phone, or any other user-side computing device.

A server, as used herein, may refer one or more server computers configured to provide certain server functionalities, such as database management and search engines. A server may also include one or more processors to execute computer programs in parallel.

Server 804 and/or client 806 may be implemented on any appropriate computing platform. FIG. 9 shows a block diagram of an exemplary computer system 900 capable of implementing server 904 and/or client 906.

As shown in FIG. 9, computer system 900 may include a processor 902, a storage medium 904, a monitor 906, a communication module 908, a database 910, and/or peripherals 912. Certain devices may be omitted and other devices may be included.

Processor 902 may include any appropriate processor or processors. Further, processor 902 can include multiple cores for multi-thread or parallel processing. Storage medium 904 may include memory modules, such as ROM, RAM, flash memory modules, and erasable and rewritable memory, and mass storages, such as CD-ROM, U-disk, and hard disk, etc. Storage medium 904 may store computer programs for implementing various processes, when executed by processor 902.

Further, peripherals 912 may include I/O devices such as keyboard and mouse, and communication module 908 may include network devices for establishing connections through the communication network 902. Database 910 may include one or more databases for storing certain data and for performing certain operations on the stored data, such as database searching.

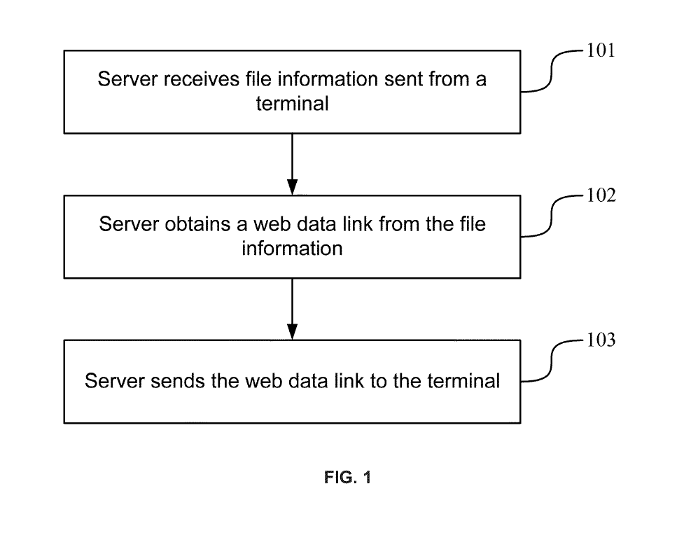

In operation, e.g., web data obtaining and/or processing, server 904 and/or client 906 may perform certain data storage processes to facilitate storing data and querying data, as depicted in FIGS. 1-7. For example, FIG. 1 depicts an exemplary server-side process flow illustrating a method for obtaining web data in accordance with various disclosed embodiments.

In Step 101, a server can obtain file information from a terminal. The file information can be, for example, file data code, data code used by computer to store files, file characteristic information, and/or any suitable information. The file information can be file information of image files. The file characteristic information can be used to describe file characteristics and/or file data characteristics. The file data characteristics can include, e.g., file hash value, image file outline information, key point information, brightness characteristic curve, etc. The file characteristic information can include data obtained from analyzing and/or processing the file data code. The file characteristic information can also include uniformly-identified or standard information.

For example, during web browsing, a user may come across a poster of a certain movie and decide to watch the movie. However, the website may only be able to provide information (e.g., images) of the poster and may not be able to provide resource link(s) for downloading the movie. As disclosed herein, the user can send the image file of the poster to the server, or send the file characteristic information obtained based on the image file to the server. The server can thus obtain file information from the user via a terminal.

In Step 102, the server can obtain a corresponding web data link based on the file information. In an exemplary embodiment, a corresponding relationship between the file characteristic information and the web data link can be stored on the server. Such corresponding relationship can be stored, e.g., via link table format. The file characteristic information can be used as a primary key, i.e., as an index for searching web data link.

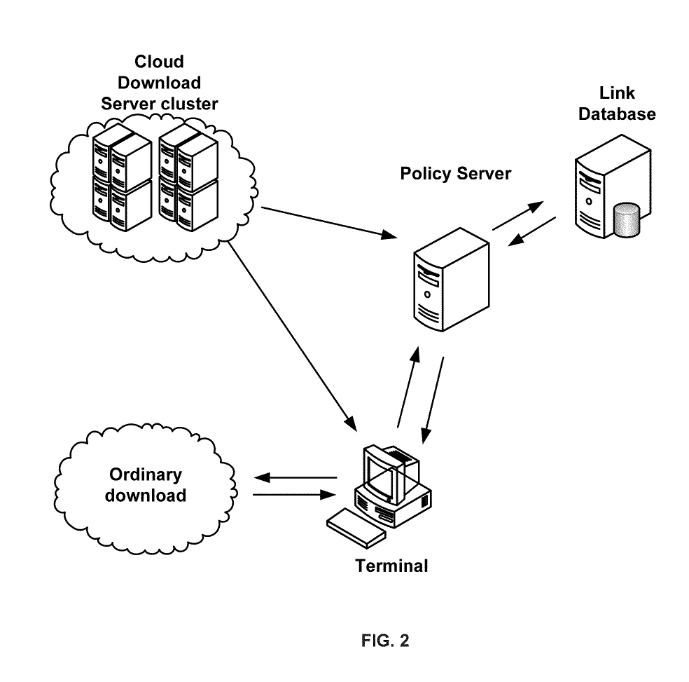

In certain embodiments, as depicted in FIG. 2, a server can include a policy server and a link database. The link database can be used to store web data links and corresponding file characteristic information. The policy server can be used to interact with, e.g., a terminal, web, and/or link database as shown in FIG. 2, and/or to obtain file characteristic information.

In some embodiments, when the file information is a file data code, the server can obtain file characteristic information based on the file data code. Based on the obtained file characteristic information and the stored corresponding relationship between the file characteristic information and the web data link, the server can obtain a corresponding web data link. A process for the server to obtain the file characteristic information based on the file data code can include, e.g., computing a whole hash value or a partial hash value of the file data code, or obtaining information of the corresponding image file(s) including, e.g., outline information, key point information, brightness characteristic curves, etc.

In other embodiments, when the file information is file characteristic information, the server can obtain a corresponding web data link directly based on the obtained file characteristic information and the stored corresponding relationship between the file characteristic information and the web data link.

In a certain embodiment, the policy server may search link database based on the received file characteristic information to find a web data resource link related to the file requested by the terminal. In an exemplary embodiment, for searching link database by the policy server, the policy server can include a cache to store the file characteristic information and the corresponding web data link in the cache. In addition, a corresponding timeout mechanism can be set in the cache. For example, each record stored in the cache can be timed out after a certain time length (or a certain period of time). Further, the time length of being stored of a record in the cache can be set in accordance with the frequency of being searched. The higher frequency the record being searched, the longer the time length of being stored.

In certain embodiments, file characteristic information can be classified to include an accurate characteristic value and a rough characteristic value. The accurate characteristic value can be the file characteristic information, only which can be able to identify the file data code characteristics including, e.g., hash values of file data code, including whole hash value(s) or partial hash value(s). The rough characteristic value can be the file characteristic information which can be able to describe partial characteristics of the file, including, e.g., outline information, key point information, brightness characteristic curve, etc. of the image file.

Web data link can be found by a searching process based on the file characteristic information. For example, the server can match up with the accurate characteristic value in the obtained file characteristic information, based on the stored corresponding relationship between the file characteristic information and the web data link. If this matching up succeeds, the server can then obtain a web data link corresponding to the accurate characteristic value. If the matching up fails, the server can then search the stored rough characteristic values to find a rough characteristic value that has greatest degree of similarity with the obtained rough characteristic value and the degree of similarity there-between can be greater than a threshold. The server can obtain a web data link corresponding to this rough characteristic value. For example, as shown in Table 1, multiple corresponding relationships between characteristic values and web data links can be stored in the link database. As shown in Table 1, the first characteristic value can be an accurate characteristic value; the other (e.g., the second, third, fourth, etc.) characteristic values can be rough characteristic values. The server can be configured to include one or multiple matching rules and similarity calculation formula for the rough characteristic values. Note that the file characteristic information can correspond to one or many web data links.

TABLE 1

| File characteristic information | | | | |
|---|---|---|---|---|
| Accurate | | | | |
| characteristic | | | | |
| value | Rough characteristic value | | | |
| First | Second | Third | Forth | |
| characteristic | characteristic | characteristic | characteristic | |
| value | value | value | value | Web data link |
| Characteristic | Characteristic | Characteristic | Characteristic | Link 1, Link 2, |
| value A | value B | value C | value D | Link3 . . . |
| . . . | . . . | . . . | . . . | . . . |

As such, the above-mentioned searching process can be classified as an accurate searching process (e.g., finding web data link based on the accurate characteristic value) and/or a rough searching process (e.g., finding web data link based on the rough characteristic value). In one embodiment, the rough searching process can be performed after the accurate searching process fails. It should be noted that the accurate searching process and the rough searching process can be performed either alone or in combination. The accurate searching process can generally have “accurate” finding results, i.e., no wrong search results are returned. That is, once an accurate characteristic value is matched up, the found web data link can be linked to a corresponding web resource. When the rough searching process is used, a corresponding web data link can still be found if major contents between the file obtained by the user and the file stored on the server are sufficiently similar. For example, a web data link can still be found for an image file, even though edge(s) of the image file are cut off.

In case the server cannot find a web data link corresponding to the file characteristic information based on the stored corresponding relationship between the file characteristic information and the web data link, the server can return to the terminal with a message indicating failure of a resource search.

In Step 103, the server can send the web data link to the terminal for the terminal to obtain corresponding web data based on the web data link. Such process for obtaining the web data can include a downloading process of the corresponding web data.

In various embodiments, the server may include multiple web data links found in Step 102 in FIG. 1. Then, when the server sends web data links to the terminal, corresponding web resource description information can also be sent to the terminal. For example, after the terminal sends file information of a certain movie poster to the server, the server may send three web data links back to the terminal. The server may comment on the information including, for example, Link 1 is a link for a downloading resource of the corresponding movie; Link 2 is a link for a preview downloading resource of the corresponding movie; and/or Link3 is a link for a mobile video version downloading resource of the corresponding movie. The terminal may display all information to the user for the user to consider suitable downloading resources.

In another embodiment, through other terminal(s) and/or other server(s), a server can obtain more web data links and corresponding file characteristic information to expand the link database. An exemplary process can include: a server receives file information and corresponding web data link from other terminals and/or servers; the server obtains file characteristic information based on the file information; and the server stores a corresponding relationship between the file characteristic information and the web data link.

In various embodiments, a corresponding functionality can be set on client terminals to enable the client terminals, during web browsing, to constantly save web data links and corresponding file information. For example, when browsing the web, a user may click on an image on a specific website which is linked to a specific download resource. The image file and the download resource link can be saved on the client terminal. In another example, when browsing the web, the user may obtain certain BT seed file. The image file(s) (and/or text files) and the web data link(s) in the BT seed file can be saved on the client terminal. The client terminal may also filter the saved image file(s) (and/or text files) and the corresponding web data links to filter out useless web data links (e.g., a redirect link, etc.). The client terminal may report the saved file information and the corresponding web data link(s) to the server based on a predefined trigger, e.g., reporting when client terminal starts, or using a scheduled reporting, etc.

In various embodiments, software similar to client terminal software can be installed on other servers (e.g., a cloud download server cluster of the same website), to store file information and corresponding web date link(s) and to send them to the server using the above mentioned saving, filtering, and reporting mechanism. Download server may have more data resources than the terminal. For example, the cloud download server cluster may store large amount of BT seeds thereon. Image file(s) and web data link(s) can then be obtained from the BT seeds.

Further, the server can be used to manage the received file information and corresponding web data link(s). For example, the server can compare the received corresponding relationship to the stored corresponding relationship. The server can abandon the received corresponding relationship if it is a duplication of the stored one.

In this manner, a server can receive file information sent from a terminal, and obtain a corresponding web data link based on the file information, and send the web data link back to the terminal for the terminal to obtain corresponding web data based on the web data link. The efficiency for obtaining web data can be improved.

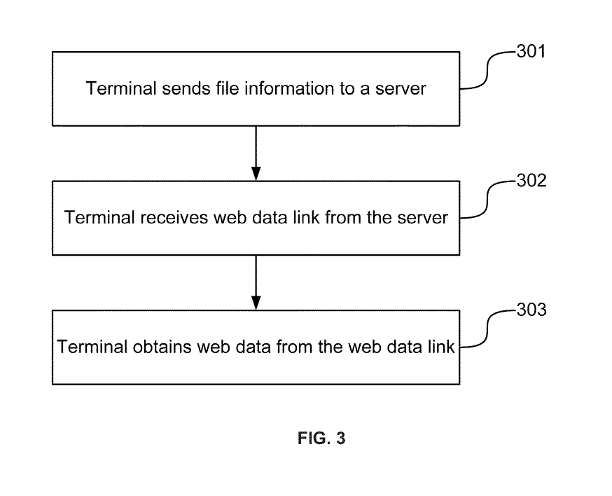

FIG. 3 depicts an exemplary terminal-side process flow illustrating a method for obtaining web data in accordance with various disclosed embodiments.

In Step 301, a terminal can send file information to a server for the server to obtain a corresponding web data link. In one embodiment, the file information can be file information of image file(s).

The file information can usually include file data code. Specifically, the terminal can obtain file characteristic information from the file data code and then send the file characteristic information to the server. Alternatively, the terminal can send the file data code directly to the server for the server to obtain corresponding file characteristic information based on the file data code.

In Step 302, the terminal can receive web data link(s) from the server.

In Step 303, the terminal can obtain corresponding web data based on the web data link(s). The obtaining process can include, e.g., a downloading process of corresponding web data.

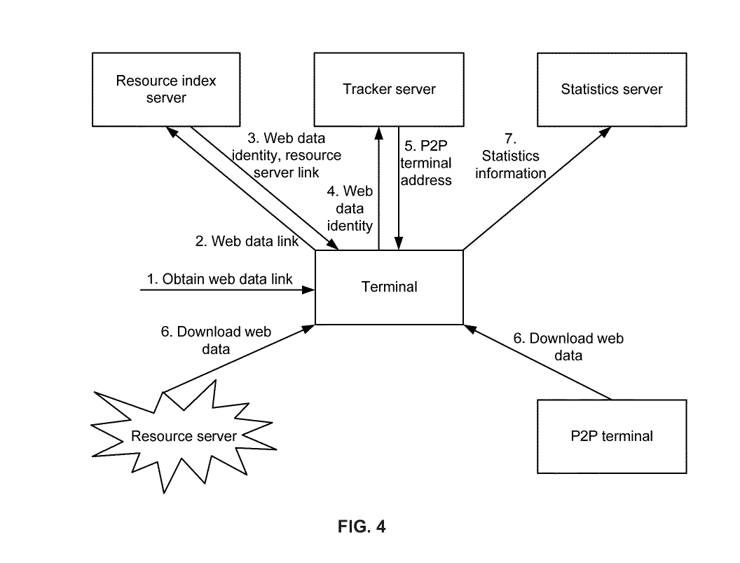

FIG. 4 depicts a web data downloading process by a terminal based on a web data link in accordance with various disclosed embodiments.

In Step 1, the terminal can obtain a web data link. For example, the terminal can obtain a web data link corresponding to file information provided by a user.

In Step 2, the terminal can send web data link to a resource index server. The user can input a web data link (e.g. URL) in client software for the client software to upload the exemplary URL to the resource index server.

In Step 3, based on the web data link, the resource index server can find a corresponding web data identity (e.g., a file hash value) and a resource server that stores the web data. The resource index server can send the web data identity and the resource server link to the terminal.

The resource index server can find the corresponding file hash value based on the web data link, and further find a resource server that stores the file based on the file hash value. The resource index server can send the file hash value and the resource server link to the terminal. In one embodiment, multiple resource servers may be found.

In Step 4, the terminal can send the received web data identity to a tracker server.

In Step 5, the tracker server can, based on the web data identity, search for P2P terminal that is downloading (or has completed the downloading of) the web data, and can notify the terminal with the P2P terminal address.

Each terminal may be registered on the tracker server when downloading web data such that the tracker server can record P2P terminals that is downloading (or has completed the downloading of) the web data corresponding to the web data identity.

In Step 6, the terminal can download the web data. Based on the resource server link provided by the resource index server and the P2P terminal address provided by the tracker server, the terminal can download corresponding web data.

It should be noted that, once Step 3 of FIG. 4 has performed, the terminal may download corresponding web data based on the resource server link provided by the resource index server.

In addition, in Step 7 in FIG. 4, after the downloading is completed, the terminal can report related statistics information (e.g., time length of downloading, downloading speed, proportions of data resources, etc.) to a statistics server.

During web browsing, in addition to the Steps 301-303 in FIG. 3, the terminal may constantly obtain, save, and send file information and corresponding web data link(s) to the server. Such saving and/or sending process may use the same process as described above.

In this manner, the terminal can send file information to the server for the server to obtain corresponding web data link(s) based on the file information. The terminal can receive web data link(s) sent from the server and can obtain corresponding web data based on the web data link(s). The efficiency for obtaining web data can then be improved.

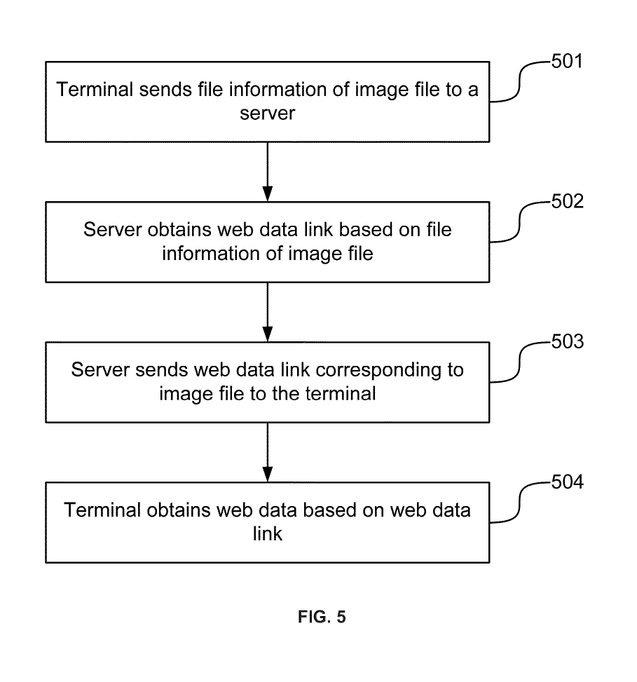

FIG. 5 depicts an exemplary process flow illustrating a method for obtaining web data in specific application scenarios.

In Step 501, a terminal can send image file information to a server. For example, when browsing web pages, a user can obtain an image file (e.g., a poster) related to a certain movie. The user may provide the image file to client software for the client software to upload the image file to the server, or to send file characteristic information of the image file to the server.

In Step 502, the server can obtain a corresponding web data link based on the file information of the image file.

The server may pre-store a corresponding relationship between the file characteristic information of the image file(s) (e.g., a hash value, outline information, key point information, brightness characteristic curve, etc.) and the web data link. The server can then obtain a web data link corresponding to the image file based on this corresponding relationship. Such process can be the same process as described in Step 102 in FIG. 1.

In Step 503, the server can send the web data link corresponding to the image file to the terminal. In various embodiments, one image file may correspond to multiple web data links. The server may send the multiple web data links to the terminal along with related information (e.g., title of the movie, synopsis of the movie, etc.) to individual web data links.

In Step 504, the terminal can obtain web data corresponding to the web data link received from the server.

Specifically, when the terminal receives multiple web data links with related information from the server, the terminal may display the web data links and related information on the client software for a user to consider. After the user selects a corresponding web data link, the terminal can download corresponding data based on the selected web data link.

In this manner, a terminal can send file information of image file(s) to a server for the server: to obtain a corresponding web data link based on the file information and to send the web data link back to the terminal. The terminal can obtain corresponding web data based on the web data link. The web data obtaining efficiency can then be improved.

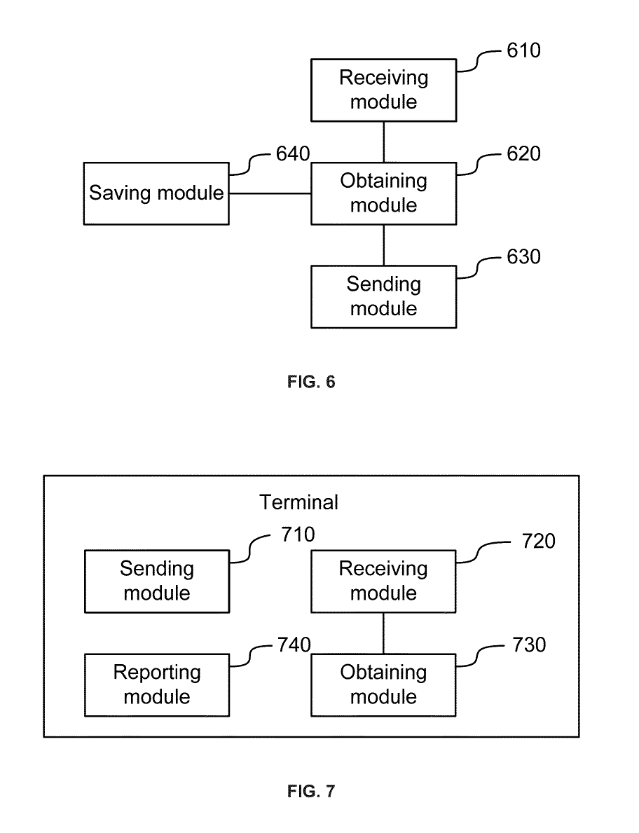

FIG. 6 depicts an exemplary server in accordance with various disclosed embodiments. The exemplary server can include a receiving module 610, an obtaining module 620, and/or a sending module 630.

The receiving module 610 can be used to receive file information sent from a terminal. The obtaining module 620 can be used to obtain corresponding web data link based on the file information. The sending module 630 can be used to send the web data link to the terminal for the terminal to obtain corresponding web data based on the web data link.

In various embodiments, the server can further include a storing module 640. The storing module 640 can be used to store a corresponding relationship between the file characteristic information and the web data link.

In some embodiments, the file information can be, for example, a file data code. The obtaining module 620 can be used to obtain the file characteristic information based on the file data code, and to obtain a corresponding web data link based on the obtained file characteristic information and corresponding relationship between the web data link and the file characteristic information stored by the storing module 640. The storing module 640 can be used to store corresponding relationship between the file characteristic information and the web data link.

In other embodiments, the file information can be, for example, file characteristic information. The obtaining module 620 can be used to obtain a corresponding web data link based on the obtained file characteristic information and the corresponding relationship between the web data link and the file characteristic information stored by the storing module 640.

The file characteristic information can include an accurate characteristic value and a rough characteristic value. The obtaining module 620 can be used to match up with the accurate characteristic value in the obtained file characteristic information based on the corresponding relationship between the file characteristic information and the web data link, stored by the storing module 640. If the matching up succeeds, a web data link can be obtained in accordance with the accurate characteristic value. If the matching up fails, the obtaining module 620 can find a rough characteristic value that has greatest degree of similarity with the rough characteristic value in the obtained file characteristic information among all rough characteristic values stored by the storing module 640. Such degree of similarity there-between can be greater than a threshold. The obtaining module 620 can then obtain a web data link corresponding to the rough characteristic value.

In one embodiment, the storing module 640 can further be used to receive file information and corresponding web data link from other terminal(s) and/or other suitable servers to obtain file characteristic information based on the file information, and to store a corresponding relationship between the file characteristic information and the web data link.

In this manner, a server can receive file information sent from a terminal; obtain a corresponding web data link based on the file information; and send the web data link to the terminal for the terminal to obtain web data based on the web data link. Efficiency for obtaining web data can be improved.

FIG. 7 depicts an exemplary terminal in accordance with various disclosed embodiments. The exemplary terminal can include a sending module 710, a receiving module 720, and/or an obtaining module 730.

The sending module 710 can be used to send file information to a server for the server to obtain a corresponding web data link based on the file information. The receiving module 720 can be used to receive the web data link sent from the server. The obtaining module 730 can be used to obtain corresponding web data based on the web data link.

In one embodiment, the sending module 710 can be used to obtain file characteristic information based on the file data code, and send the file characteristic information to the server; or to send the file data code to the server.

In one embodiment, the terminal can further include a reporting module 740. The reporting module 740 can be used to obtain file information and corresponding web data link, and to send them to the server.

In this manner, a terminal can send file information to a server for the server to obtain a corresponding web data link based on the file information; can receive the web data link sent from the server; and can obtain corresponding web data based on the web data link to improve web data obtaining efficiency.

One of ordinary skill in the art would appreciate that the disclosed modules in FIG. 6 and/or FIG. 7 can be configured in one apparatus or configured in multiple apparatus as desired. The modules disclosed herein can be integrated in one module or in multiple modules. Each of the modules disclosed herein can be divided into one or more sub-modules, which can be recombined in any manner.

The disclosed embodiments (e.g., as shown in FIGS. 1-7) can be example only. One of ordinary in the art would appreciate that suitable software and/or hardware (e.g., a universal hardware platform) may be included and used to obtain web data. For example, obtaining web data can be implemented by hardware only. However, obtaining web data can also be implemented by software products only. The software products can be stored in a storage medium. The software products can include suitable commands to enable a terminal device (including e.g., a mobile phone, a personal computer, a server, or a network device, etc.) to implement the disclosed embodiments for obtaining web data.

Other applications, advantages, alternations, modifications, or equivalents to the disclosed embodiments are obvious to those skilled in the art.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods and apparatus can be used in a variety of internet applications, especially in applications for obtaining web data with high efficiency and with reduced waste of web sources. By using the disclosed methods and apparatus, the efficiency for obtaining web data can be improved by, for example, obtaining file information from a terminal; obtaining a web data link corresponding to the file information; and sending the web data link back to the terminal for the terminal to obtain corresponding web data based on the web data link. In one example, by using the disclosed methods and apparatus, when a user comes across a poster on a forum regarding a latest movie, downloading links for this movie can be provided directly on the forum for the user to download web data of the movie.

### REFERENCE SIGN LIST

Receiving module 610
Obtaining module 620
Sending module 630
Storing module 640
Sending module 710
Receiving module 720
Obtaining module 730
Reporting module 740

What is claimed is:

1. A method for obtaining web data comprising:
pre-storing a corresponding relationship between file characteristic information and a web data link;
receiving file information sent from a terminal;
obtaining a web data link corresponding to the file information at least based on the corresponding relationship, wherein the file information includes the file characteristic information; and
sending the web data link to the terminal for the terminal to obtain web data based on the web data link.

2. The method of claim 1, wherein the file information is a file data code for obtaining the file characteristic information and wherein obtaining the web data link includes:
obtaining the file characteristic information based on the file data code; and
obtaining the web data link based on the obtained file characteristic information and the pre-stored corresponding relationship.

3. The method of claim 1, wherein the file information is the file characteristic information, and wherein obtaining the web data link includes:
obtaining the web data link based on the file characteristic information and the pre-stored corresponding relationship.

4. The method of claim 2, wherein the file characteristic information includes an accurate characteristic value and a rough characteristic value, wherein obtaining the web data link includes:
matching up with the accurate characteristic value in the file characteristic information of the file information, based on the pre-stored corresponding relationship; and
when the matching up succeeds, obtaining the web data link corresponding to the accurate characteristic value; and
when the matching up fails, finding a rough characteristic value that has greatest degree of similarity to the rough characteristic value of the file characteristic information provided of the file information, from pre-stored rough characteristic values of the file characteristic information, and the degree of similarity is greater than a threshold; and
obtaining the web data link corresponding to the found rough characteristic value.

5. The method of claim 2, wherein the pre-storing of the corresponding relationship includes:
receiving file information and a corresponding web data link from a second terminal, a second server, or combinations thereof; and
obtaining the file characteristic information from the received file information; and
pre-soring the corresponding relationship between the file characteristic information and the corresponding web data link.

6. The method of claim 1, wherein the file information includes file information of one or more image files.

7. A server comprising:
a storing module configured to store a corresponding relationship between file characteristic information and a corresponding web data link;
a receiving module configured to receive file information from a terminal;
an obtaining module configured to obtain a web data link corresponding to the file information at least based on the corresponding relationship, wherein the file information includes the file characteristic information; and
a sending module configured to send the web data link to the terminal for the terminal to obtain web data corresponding to the web data link.

8. The server of claim 7, wherein the file information is a file data code for providing the file characteristic information and wherein the obtaining module is configured to: obtain the file characteristic information based on the file data code, and to obtain the web data link based on the obtained file characteristic information and the corresponding relationship stored by the storing module.

9. The server of claim 7, wherein the file information is the file characteristic information and wherein the obtaining module is configured to obtain the web data link based on the file characteristic information and the corresponding relationship stored by the storing module.

10. The server of claim 8, wherein the file characteristic information includes an accurate characteristic value and a rough characteristic value, wherein the obtaining module is configured to:
match up with the accurate characteristic value in the file characteristic information provided by the file information, based on the corresponding relationship stored by the storing module;
when the matching up succeeds, obtain the web data link corresponding to the accurate characteristic value; and
when the matching up fails, find a rough characteristic value that has greatest degree of similarity to the rough characteristic value of the file characteristic information provided of the file information, from pre-stored rough characteristic values of the file characteristic information, and the degree of similarity is greater than a threshold, and to obtain the web data link corresponding to the found rough characteristic value.

11. The server of claim 8, wherein the storing module is configured to receive file information and the corresponding web data links sent from other a second terminal, a second server, or a combination thereof, to obtain the file characteristic information based on the file information, and to store the corresponding relationship between the file characteristic information and the corresponding web data link.

12. A method for obtaining web data comprising:
sending file information to a server for the server to obtain a web data link corresponding to the file information, wherein the file information provides file characteristic information and the web data link is obtained at least based on a corresponding relationship between the file characteristic information and a corresponding web data link;
receiving the web data link from the server; and
obtaining web data corresponding to the web data link.

13. The method of claim 12, wherein the file information includes a file data code and wherein sending the file information includes:
obtaining the file characteristic information based on the file data code, and sending the file characteristic information to the server; or
sending the file data code to the server.

14. The method of claim 12, further including:
obtaining the file information and corresponding web data link; and
sending the file information and corresponding web data link to the server.

15. The method of claim 12, wherein the file information includes file information of one or more image files.

16. A terminal comprising:
a sending module configured to send file information to a server for the server to obtain a web data link corresponding to the file information, wherein the file information provides file characteristic information and the web data link is obtained at least based on a corresponding relationship between the file characteristic information and a corresponding web data link;
a receiving module configured to receive the web data link sent from the server; and
an obtaining module configured to obtain web data based on the web data link.

17. The terminal of claim 16, wherein the file information includes a file data code and the sending module is configured to obtain the file characteristic information based on the file data code and to send the file characteristic information to the server; or to send the file data code to the server.

18. The terminal of claim 16, further including:
a reporting module configured to obtain the file information and the web data link and to send the obtained file information and the web data link to the server.
